(19) United States
(12) Patent Application Publication
(10) Pub. No.: US 2020/0404772 A1
(43) Pub. Date: Dec. 24, 2020

(54) Compact Rare-Earth Superconducting Cyclotron

(71) Applicant: Antaya Science & Technology, Hampton, NH (US)

(72) Inventor: Timothy A. Antaya, Hampton, NH (US)

(73) Assignee: Antaya Science & Technology, Hampton, NH (US)

(21) Appl. No.: 16/906,600

(22) Filed: Jun. 19, 2020

Related U.S. Application Data
(60) Provisional application No. 62/864,094, filed on Jun. 20, 2019.

(51) Int. Cl. H05H 7/04; H05H 13/00; H05H 7/02; H01F 6/06

(52) U.S. Cl. CPC H05H 7/04; H05H 13/005; H05H 2007/025; H01F 6/06; H05H 7/02

(57) ABSTRACT

A compact rare-earth superconducting cyclotron includes a magnetic yoke, a pair of superconducting coils, and a pair of rare-earth poles. The magnetic yoke defines a chamber contained within the magnetic yoke. The superconducting coils are contained in the chamber defined in the magnetic yoke and are positioned on opposite sides of a median acceleration plane in the chamber. Each rare-earth pole includes a rare-earth metal and is contained in the chamber defined in the magnetic yoke on opposite sides of the median acceleration plane. Each of the rare-earth poles also extends inward toward a central axis from one of the superconducting coils, is physically separated from the magnetic yoke, and is separated by at least 5 cm from the other rare-earth pole.

### RELATED APPLICATION

This application claims the benefit of U.S. Provisional Application No. 62/864,094, filed 20 Jun. 2019, the entire content of which is incorporated herein by reference.

### BACKGROUND

The cyclotron, which was invented about ninety years ago by Livingston and Lawrence [see E. Lawrence and N. Edlefsen, “On the Production of High Speed Protons”, 72 Science 376 (1930); E. O. Lawrence and M. S. Livingston, “The Production of High Speed Protons without the Use of High Voltages”, 38 Physical Review 834 (1931); and E. O. Lawrence and D. Cooksey, “On the Apparatus for the Multiple Acceleration of Light Ions to High Speeds”, 50 Physical Review 1131 (1936)] remains the workhorse apparatus for delivering protons and ions at moderate kinetic energies. Their twin advantages are robust simplicity and the ready capability for high intensity; once manufactured, a single energizing coil and ion source may deliver a reliable high current of particles, often at a single extracted energy.

A key advance in cyclotron technology has been the steady adoption and improvement of superconducting technology, the first superconducting cyclotron being realized in the K500 cyclotron by Blosser, et al., “Medical accelerator projects at Michigan State University”, in Proceedings of the 13th Particle Accelerator Conference, Chicago (Ill.), 1989 (JACoW) 742-746 (1989).

In recent years, several superconducting cyclotrons extracting protons with kinetic energies up to Eₖ=250 MeV have been developed with the aim of making proton therapy systems more compact and affordable [see J. Kimand and H. Blosser, “Optimized Magnet for a 250 MeV Proton Radiotherapy Cyclotron”, 600 AIP Conference Proceedings 345 (2001); M. Schillo, et al., “Compact Superconducting 250 MeV Proton Cyclotron for the PSI PROSCAN Proton Therapy Project”, 600 AIP Conference Proceedings 37 (2001); and J. M. Schippers, et al., “The Superconducting Cyclotron and Beam Lines of PSI's New Proton Therapy Facility ‘PROSCAN’, Proceedings of the 17th International Conference on Cyclotrons and Their Applications, Tokyo, Japan (JACoW) (2004); and H. Roecken, et al., “The Varian 250 MeV Superconducting Compact Proton Cyclotron: Medical Operation of the 2nd Machine, Production and Commissioning Status of Machines No. 3 to 7”, Proceedings of the 19^{th}International Conference on Cyclotrons and their Applications, Lanzhou, China (JACoW) 283-285 (2010)]. Indeed, the highest dipole field obtained in a particle accelerator of any type today is the 9 T achieved in the Mevion medical synchrocyclotron [see V. Smirnovand and S. Vorozhtsov, “Modern Compact Accelerators of Cyclotron Type for Medical Applications”, 47 Physics of Particles and Nuclei 863 (2016), of which there are several commercial examples. Superconducting cyclotrons have also been developed for lower extraction energies—particularly for isotope production and for ion therapy. An advantage of high field in a low-energy cyclotron (say, at 12 MeV) is that the complete magnet (including yoke) may be placed within a compact cryostat.

At moderate-to-high energies, the challenge remains as to how to simultaneously obtain both a high average field, B, which allows the overall mass and volume of the cyclotron to be reduced (roughly as 1=B³) while also creating a suitable field profile and focusing to produce isochronous behavior and, thereby, to allow for the highest proton intensities.

### SUMMARY

A cyclotron and its construction and operation are described herein, where various embodiments of the apparatus and methods may include some or all of the elements, features and steps described below.

A compact rare-earth superconducting cyclotron of this disclosure can include a magnetic yoke, a pair of superconducting coils, and a pair of rare-earth poles. The magnetic yoke defines a chamber contained within the magnetic yoke. The superconducting coils are contained in the chamber defined in the magnetic yoke and are positioned on opposite sides of a median acceleration plane in the chamber. Each rare-earth pole includes a rare-earth metal and is contained in the chamber defined in the magnetic yoke on opposite sides of the median acceleration plane. Each of the rare-earth poles also extends inward toward a central axis from one of the superconducting coils, is physically separated from the magnetic yoke, and is separated by at least 5 cm from the other rare-earth pole.

Components, features and characterizations of various examples of the above-described cyclotron are provided, below, and can be incorporated alone or in various combinations thereof. The rare-earth metal can be holmium or gadolinium. The magnetic yoke can include iron. Each of the rare-earth poles can include an outer surface facing away from the median acceleration plane, and the outer surface can feature a cut profile that adjusts a magnetic-field profile generated in the median acceleration plane. The compact rare-earth superconducting cyclotron can include a pair of cryostats, each containing one of the rare-earth poles and one of the superconducting coils. The compact rare-earth superconducting cyclotron can include an ion source configured to inject an ion into the median acceleration plane for acceleration therein. The cyclotron can be an isochronous cyclotron. The compact rare-earth superconducting cyclotron can include at least one cryogenic refrigerator thermally coupled with the superconducting coils and with the rare-earth poles. The electrode is coupled with a radiofrequency voltage source and is configured to generate a field that accelerates an ion orbiting outwardly across the median acceleration plane. The rare-earth poles include an inner ring, an outer skirt ring, and spiral-shaped hills extending between the inner ring and the outer skirt ring.

A method for accelerating an ion in a cyclotron includes injecting an ion into a chamber defined inside a magnetic yoke at an inner radius; providing a voltage from a radiofrequency voltage source to an electrode in the chamber to generate an oscillating field from the electrode that accelerates the ion in an outwardly spiraling orbit across a median acceleration plane; using a cryogenic refrigerator to maintain (a) superconducting coils on opposite sides of the median acceleration plane and (b) rare-earth poles at a temperature at or below that at which a rare-earth metal of the rare-earth poles transitions to a ferromagnetic state. The rare-earth poles are separated by a gap of least 5 cm across the median acceleration plane and are physically separated from the magnetic yoke across the median acceleration plane. A voltage is provided to the superconducting coils to generate superconducting current in the superconducting coils. The superconducting coils magnetize the rare-earth poles and the magnetic yoke; and the superconducting coils, the rare-earth poles, and the yoke generate a radially increasing magnetic field in the median acceleration plane that accelerates the ion in an outwardly spiraling orbit from the inner radius to an outer extraction radius. The accelerated ion is extracted from the chamber at the outer extraction radius.

Implementations of the method may include one or more of the following features. The method can be performed to extract the ion with an energy of at least 70 mev. The yoke can be maintained at room temperature as the ion is accelerated. Additionally, a magnetic field of at least 4.5 T can be generated in the median acceleration plane.

### BRIEF DESCRIPTION OF THE DRAWINGS

FIG. 1 includes logarithmic and linear (inset) plots of a survey of cyclotron masses, as a function of extracted proton energy, Eₖ=K(Q²=A), are shown with an approximate expression which predicts the mass of a cyclotron for a given energy and B-field.

FIG. 2 is a plot of magnetic field density (B) of holmium with an applied field (II) curve at 4.2 K, where the onset of saturation at 3.9 T can be seen.

FIG. 3 is a cross-sectional schematic of the magnetic materials in a 70 MeV proton cyclotron.

FIG. 4 is a three-dimensional OPERA rendering of the upper half of a cyclotron magnet.

FIG. 5 is an outline of the median-plane-facing side of a lower holmium pole, where back-cuts are applied to the opposite side of this pole.

FIG. 6 is a three-dimensional OPERA rendering of the back-cut of a holmium pole with a diameter of 620 mm.

FIG. 7 is a three-dimensional OPERA rendering of steel cone and holmium ring lying over the holmium pole of FIG. 6 as seen from the median plane.

FIG. 8 plots contours showing the variation of magnetic-field strength within a cross-section of the superconducting coil pack; the cross-section was chosen through the azimuth at which the flux density is strongest.

FIG. 9 is a density map indicating the strength of the vertical median-plane (z=0) field. The spiral focusing is visible. The minimum valley field is 4.1 T, and the maximum hill field is 5.4 T, whilst the azimuthally averaged field strength increases with radius.

FIG. 10 shows azimuthally averaged flux density [symbol] Bₛᵢₘ(r, θ) [symbol] for the OPERA field map compared to the ideal isochronous field, B(r)=γ(r)B₀.

FIG. 11 plots median-plane flutter multiplied by the spiral factor term, F(1+2 tan²ξ(r)), compared to the field index, n.

FIG. 12 plots azimuthally averaged radii of equilibrium orbits for the 70 MeV cyclotron design, calculated from the OPERA-modelled field using the GENSPEO code.

FIG. 13 plots the variation of radial tune, νₓ, and axial tune, ν_{z}, with energy in the 70 MeV cyclotron design, calculated from the OPERA-modelled field using the GENSPEO code.

FIG. 14 plots the variation of radial and axial tunes with energy in the 70 MeV cyclotron design, calculated from the OPERA-modelled field using the GENSPEO code and shown as a working point diagram; resonances up to third order are shown.

FIG. 15 plots the variation of proton radius with turn number, obtained using the Z3CYCLONE code.

FIG. 16 plots the variation of axial oscillation amplitude of a reference proton with turn number.

FIG. 17 plots the variation of relative proton and RF phase with turn number, obtained using the Z3CYCLONE code.

FIG. 18 plots the variation of proton kinetic energy with turn number, obtained using the Z3CYCLONE code.

In the accompanying drawings, like reference characters refer to the same or similar parts throughout the different views; and apostrophes are used to differentiate multiple instances of the same item or different embodiments of items sharing the same reference numeral. The drawings are not necessarily to scale; instead, an emphasis is placed upon illustrating particular principles in the exemplifications discussed below. For any drawings that include text (words, reference characters, and/or numbers), alternative versions of the drawings without the text are to be understood as being part of this disclosure; and formal replacement drawings without such text may be substituted therefor.

Discussed herein is a method of creating an isochronous, high-field cyclotron based on a rare-earth ‘flying pole’; we study an exemplary isochronous 70 MeV design that utilizes a 4:52-T central field. We show the first realistic method of combining a cold holmium pole, which enables the strong focusing at high fields, with a superconducting NbTi coil and a warm yoke. The result delivers high currents of 70 MeV protons from a cyclotron of unprecedentedly small size; such a design enables low-energy proton therapy—targeting, for example, ocular therapy or surface lesions—at high dose rates that would also enable techniques, such as FLASH therapy. Intensities of several-hundred microamperes would also allow it to be used for the generation of medical isotopes. A source of 70 MeV protons is also very attractive for uses in radiobiological research, as it provides a sample penetration depth well-suited for typical experimental geometries.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail, below, may be implemented in any of numerous ways, as the subject matter is not limited to any particular manner of implementation. Examples of specific implementations and applications are provided primarily for illustrative purposes.

Unless otherwise herein defined, used or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially (though not perfectly) pure, as practical and imperfect realities may apply; e.g., the potential presence of at least trace impurities (e.g., at less than 1 or 2%) can be understood as being within the scope of the description. Likewise, if a particular shape is referenced, the shape is intended to include imperfect variations from ideal shapes, e.g., due to manufacturing tolerances. Percentages or concentrations expressed herein can be in terms of weight or volume.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly. The term, “about,” can mean within ±10% of the value recited. In addition, where a range of values is provided, each subrange and each individual value between the upper and lower ends of the range is contemplated and therefore disclosed.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to be limiting of exemplary embodiments. As used herein, singular forms, such as those introduced with the articles, “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

Additionally, the various components identified herein can be provided in an assembled and finished form; or some or all of the components can be packaged together and marketed as a kit with instructions (e.g., in written, video or audio form) for assembly and/or modification by a customer to produce a finished product.

In a cyclotron, ions are injected at an inner radius proximate a central axis and accelerated outwardly across a median acceleration plane. A voltage/electric current is applied from a radiofrequency voltage source to electrode plates extending on opposite sides of the median acceleration plane in the form of a dee to accelerate the ions in a spiral orbit to an extraction radius, where the ion is extracted from the cyclotron. The path and energy of the ions through the cyclotron are governed by the magnetic field generated by the superconducting coils, the rare-earth poles, and the surrounding magnetic yoke. In an isochronous cyclotron, contoured “flutter” pole pieces having a sector periodicity inside the yoke apply an axial restoring force during ion acceleration. During the ion acceleration, the superconducting coils and the rare-earth poles are cooled by one or more cryogenic refrigerators—the superconducting coils to a temperature at or below their superconducting transition temperature and the rare-earth poles to a temperature at or below that at which they transition to their ferromagnetic state.

The kinetic energy, Eₖ, of an ion with mass, A (in a.m.u.), and charge, Q (in units of e, the elementary charge on an electron), at extraction radius, rₑₓₜ, in a cyclotron of field strength, B, is given by the following equation:

$${E}_{k} = \frac{{( e B {r}_{e x t} )}^{2}}{2 u} ( \frac{{Q}^{2}}{A} ) = K ( \frac{{Q}^{2}}{A} ) , \qquad ( 1 )$$

where u is 1 atomic mass unit (a.m.u.). Given Eq. 1, we may construct an approximate expression for the mass of a cyclotron that accelerates protons (Q²=A=1) to a kinetic energy, Eₖ. K is known as the bending constant for an isochronous cyclotron and is useful for comparing the bending strength of different cyclotron magnets. We assume that the cyclotron has a steel yoke (of density, ρ) that is spherical with an outer radius, r_{cyc}, which is related to the particle extraction radius, rₑₓₜ by a factor, κ=r_{cyc}=rₑₓₜ. The mass of the sphere, m_{cyc}=4πr³_{cyc} ρ is related to Eₖ and B as follows:

$${m}_{c y c} = \frac{32 \sqrt{2} {u}^{3} {πκ}^{3}}{9 {e}^{2}} \frac{{E}_{k}^{3 / 2}}{{B}^{3}} , \qquad ( 2 )$$

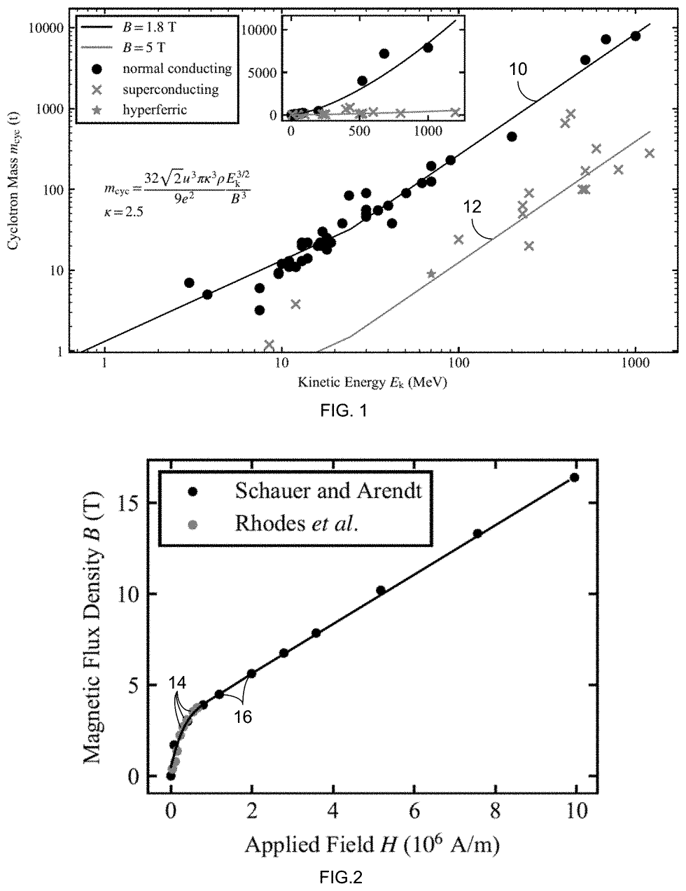

which shows the 1/B³ scaling at a given Eₖ. At extraction, cyclotrons with resistive coils are limited practically to a magnetic flux density, B<2 T. Superconducting cyclotrons offer a much higher flux density at extraction, often as much as B=5 T, and, in the case of the Mevion S250 synchrocyclotron, have achieved fields over B=9 T. FIG. 1 compares the derived relation of Eq. 2 to data obtained from a representative range of research and commercial, normal-conducting (circle plots) and superconducting (“x” plots) cyclotrons that generate a 1.8-T field 10 and a 5-T field 12. High-field superconducting cyclotrons are seen to be significantly more compact than normal-conducting cyclotrons. Also shown is a ‘hyperferric’ design (star plot), which is discussed in detail, below. The predicted position on this plot of the 70-MeV design, discussed herein, is shown. We see that high B-field superconducting magnets can obtain a cyclotron of a given Eₖ that is at least an order of magnitude lighter than the corresponding normal-conducting equivalent. The main plot tracks the cyclotron mass (y-axis) on a logarithmic scale, while the inset plot tracks the cyclotron mass on a linear scale.

Low-energy, isochronous, superconducting cyclotrons (Eₖ<20 MeV) may rely on the azimuthal varying field (AVF) produced by an ordinary steel pole to provide sufficient axial focusing of ions, whereas higher-energy isochronous cyclotron designs (with energies perhaps larger than Eₖ=100 MeV) require additional axial focusing, which can be provided by so-called flutter coils that increase the AVF. In the intermediate energy range, the use of a high-permeability material for the cyclotron pole is proposed here as means of generating the necessary AVF. Rare-earth metals, such as gadolinium and holmium, are candidate pole materials, each having saturation magnetizations significantly higher than that of low-carbon steel; gadolinium has the advantage of having a much higher Curie temperature. but holmium saturates at a higher field.

Holmium is a rare-earth metal that undergoes an anti-ferromagnetic-to-ferromagnetic phase transition with decreasing temperature at around approximately 20 K. In the ferromagnetic state at 4.2 K, holmium has the highest saturation magnetization of any element: μ₀Mₛ=3.9 T. The magnetic dependence of holmium on temperature (down to 4.2 K) and on applied magnetic field (up to μ₀H=1.6 T) was characterized in B. L. Rhodes, et al., “Magnetic Properties of Holmium and Thulium Metals”, 109 Phys. Rev. 1547 (1958); these magnetic measurements were performed on a torus of rectangular cross-section around which a normal conductor was wound and a current applied. The B-H curve of holmium at 4.2 K in a much-stronger applied magnetic field (up to μ₀H=12.5 T) was then characterized in W. Schauer and F. Arendt, “Field Enhancement in Superconducting Solenoids by Holmium Flux Concentrators”, 23 Cryogenics 562 (1983); in this case, two holmium cylinders were placed as flux concentrators within a Nb₃Sn superconducting solenoid. A gap between the cylinders of 5.5 mm allowed field measurements to be taken using a Hall probe. The B-H data from both papers are in good agreement and are shown in FIG. 2 with a fit from M. A. Norsworthy, “Characterization of Ferromagnetic Saturation at 4.2 K of Selected Bulk Rare Earth Metals for Compact High-Field Superconducting Cyclotrons, Master's thesis, Massachusetts Institute of Technology, Department of Nuclear Science and Engineering (2010). The onset of magnetic saturation at 3.9 T can be seen in FIG. 2, which plots the data from the Rhodes paper 14 and from the Schauer paper 16.

There have been various implementations of rare-earth metals for field enhancement in superconducting magnets. Examples include the use of holmium both as a flux concentrator in superconducting solenoids and as a pole piece in place of traditional iron alloys. In these cases, rare-earth metals were used to boost already-high-field systems beyond the quench limit of commercially available superconductors, which lies around 8 T for NbTi and 13 T for Nb₃Sn. In contrast, in our present study, we operate the superconducting coils well below the quench limit of NbTi; and we use the large 3.9-T saturation magnetization of holmium to create the required azimuthally varying B-field (AVF); using only (saturated) iron poles would give insufficient AVF.

Further examples of the use of rare-earth metal poles have been in high-gradient superconducting quadrupoles for linear accelerators (linacs), in a 7.5-T quadrupole design for magnetic circular dichroism experiments, and in an octupole design for photon-scattering experiments. Holmium has also been proposed as a material for use in superconducting wigglers for beam-emittance reduction in damping rings, for example in the Compact Linear Collider in which a larger B-field decreases the minimum achievable emittance [see P Peiffer, et al., “New Materials and Designs for Superconductive Insertion Devices”, Proceedings of the 23rd Particle Accelerator Conference, Vancouver, Canada (JACoW) (2009), and D. Schoerling, “Superconducting Wiggler Magnets for Beam-Emittance Damping Rings”, Ph.D. thesis, Technical University Bergakademie Freiberg, Faculty of Mechanical, Process and Energy Engineering (2012)]. However, while designs exist for superconducting rare-earth cyclotrons and cyclotron-like accelerators, an example has yet to be realized. One such design was a compact FFAG accelerator for 400 MeV u⁻¹ carbon ions [B. Qin and Y. Mori, “Compact Superferric FFAG Accelerators for Medium Energy Hadron Applications”, 648 Nuclear Instruments and Methods in Physics Research Section A: Accelerators, Spectrometers, Detectors and Associated Equipment 28 (2011)], which proposed gadolinium poles to increase the possible field gradient while maintaining a near-room-temperature magnet; in this design, the poles are in direct contact with the iron yoke. However, it is not clear in this design how the entire magnet could be maintained sufficiently below the Curie temperature of c. 290 K to make full use of the Gd poles.

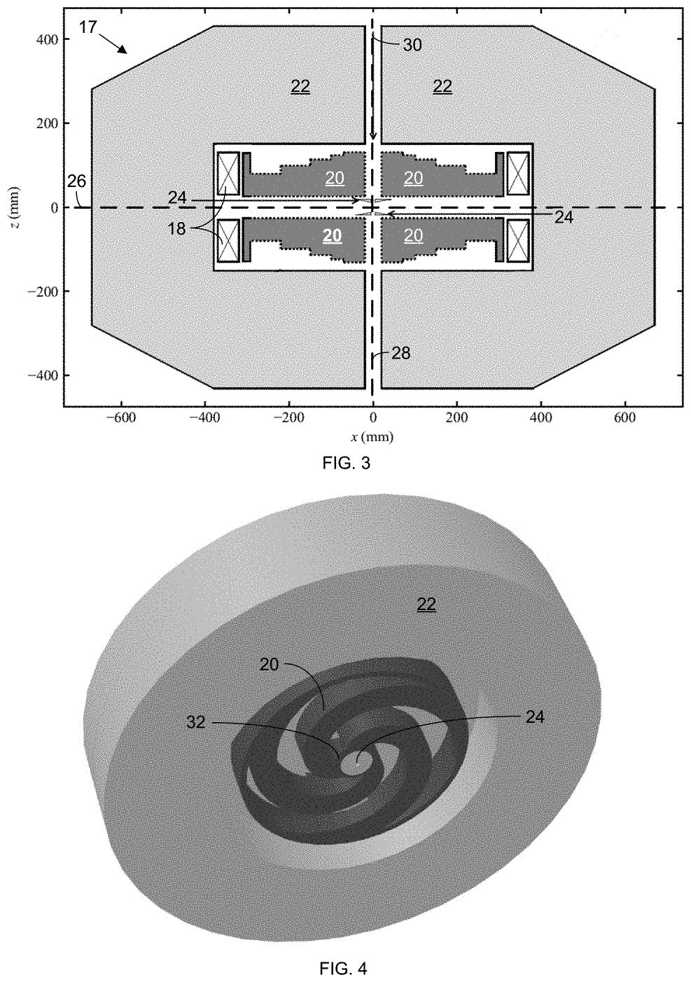

A design of this disclosure, shown in FIG. 3, differs in that the cyclotron 17 utilizes both superconducting coils 18 and a (cold) rare-earth pole 20, such as a holmium pole, in conjunction with a (warm) iron yoke 22. We propose the term ‘hyperferric’ for such a magnet; ordinary superferric magnets have iron-dominated fields in which the driving coils may be either resistive or superconducting, whereas we use a rare-earth pole 20 instead of an iron pole. Physically separating the rare-earth pole 20 from the yoke 22 allows it to be cooled with a small cold mass and volume—in what we term a ‘flying pole’ configuration; this design offers enormous practical advantages for any cyclotron 17 of 70 MeV or greater extraction energy because the yoke 22, which constitutes the bulk of the overall cyclotron mass, can be kept at room temperature. The superconducting coils 18 produce the large average magnetic field required for a compact overall magnet size, while the shaped rare-earth poles 20 allow the largest field variation between the hills and valleys on the pole surfaces. While holmium poles 20 need to be cooled significantly below their Curie temperature of 20 K (actually to 4.2 K to maximize their saturation magnetization), this separation of pole 20 and yoke 22 (the flying pole) offers some advantages in the magnet design as will be explored, below. The nearby superconducting coils 18 must already be cooled (e.g., by a cryogenic refrigerator), so it is not onerous to also cool the poles 20; one may use a pair of cryostats (not shown) to contain the superconducting coil 18 and pole 20 on either side of the room-temperature electrode dees (not shown but extending over the beam chamber) and beam vacuum chamber.

An earlier design—the so-called Megatron K250 cyclotron—aimed at a proof-of-principle 250-MeV proton cyclotron with holmium poles [M. A. Norsworthy, “Characterization of Ferromagnetic Saturation at 4.2 K of Selected Bulk Rare Earth Metals for Compact High-Field Superconducting Cyclotrons,” Master's thesis, Massachusetts Institute of Technology, Department of Nuclear Science and Engineering (2010), and J. Zhang, T. Antaya, and R. Block, “Beam Dynamics of a Compact SC Isochronous Cyclotron—Preliminary Study of Central Region, Proceedings of the 2nd International Particle Accelerator Conference, San Sebastian. Spain (JACoW) (2011)]; such a cyclotron could have applications in high-dose-rate proton therapy and for detection of fissile materials. While an isochronous field and sufficient flutter was obtained, this design was not yet practical and had insufficient internal aperture to accommodate the dees, cryostat and accelerated beam. The design presented here resolves this issue with a larger pole gap of, e.g., 5.2 cm, and we believe it is the first practical design of a so-called hyperferric cyclotron.

### Magnet Design of a Hyperferric Cyclotron at 70 MeV

We have applied the flying-pole ‘hyperferric’ approach, described above, in a feasible design with the aim of constructing a prototype; we have studied a 70-MeV proton-extraction energy because increasing the central field from around 1.8 T (normal conducting) to 4.52 T (hyperferric) drastically reduces the size of such a system. As we saw above, a 4.52-T, 70-MeV cyclotron has less than one-tenth the mass of its normal-conducting equivalent and turns such a proton source from the preserve of regional facilities to a system that could readily be installed in a small laboratory; the cost often scales quite closely with the cyclotron mass.

The use of a flying pole 20 allows us to retain a room-temperature yoke 22 constructed from ordinary 10:10 steel whilst also allowing the use of holmium poles 22. Holmium may be chosen over gadolinium due its larger saturation field and because it can be accommodated in the overall design because the coils 18 are already superconducting (so that a common cryogenic system can be used to cool both), and sufficient AVF can be obtained across a realistic pole gap. Nevertheless, gadolinium may be selected for the flying poles for operations with extraction energies between 20 MeV and 50 MeV. The main cyclotron parameters are shown in Table I, below, where we note, in particular, the remarkably small yoke size and mass.

This design uses three spiral sectors to provide axial focusing. Features of the design include the following:
the use of a single pair of rare-earth pole tips with sufficient space for a cryostat, accelerating structure, and structural support that has not previously been described for a cyclotron;
physical separation of the rare-earth poles from the yoke (the ‘flying pole’ approach), which allows the yoke to operate at room temperature while the rare-earth poles operate at 4.2 K;
shaping of the reverse (outer, non-orbit-facing) side of the rare-earth poles (which we term ‘back-cut poles’) to adjust the field profile, increasing the volume of ferromagnetic material close to particles orbiting in the median plane and thus enabling stronger focusing.

Three spiral sectors provide axial focusing at the larger orbit radii with a conventional dee and stem arrangement for acceleration. Protons may be axially injected from an external 10-GHz electron-cyclotron-resonance (ECR) ion source delivering approximately 10-keV protons through a conventional spiral inflector and puller arrangement in a weak-focusing cone field approximately 2% greater than the central field value, B₀ of 4.52 T. Conventional particle extraction using electrostatic deflectors will allow currents of at least 100 nA at good extraction efficiencies of perhaps 80%, sufficient for high-dose-rate particle therapy at many Gy s⁻¹; self-extraction, however, could increase the extracted current to several hundred microamperes and thereby allow use of this cyclotron for isotope production using higher-energy protons up to 70 MeV.

TABLE 1
70-MeV cyclotron parameters:

| Parameter | Value |
|---|---|
| accelerated species | protons |
| extraction energy | 70 MeV |
| extracted current | at least 100 nA |
| ion source | external ECR, 10 GHz |
| central field | 4.52 T |
| pole layout | 3-fold, Archimedean spiral |
| RF system | 3 dees, 40 kV per crossing |
| cyclotron frequency | 69 MHz |
| harmonic number | 3 |
| pole gap at hills | 26 mm |
| extraction radius | 254 mm |
| pole radius | 310 mm |
| yoke radius | 670 mm |
| yoke height | 862 mm |
| yoke mass | <9 tons (8,165 kg) |

Magnet modeling has been performed with OPERA software using the TOSCA solver [see Z3CYCLONE Instruction Manual, Version 4.0, Michigan State University NCSL Accelerator Group (1993)], both of which are well-proven for such designs. The cyclotron magnet 17 shown in the cross-sectional schematic illustration of FIG. 3 comprises the following four parts:
a low-carbon 10:10 steel yoke 22;
a pair of superconducting NbTi energizing coils 18;
a back-cut flying holmium pole pair 20; and
a central 10:10 steel ring and cone 24 to provide weak focusing for injected protons 30.

The beam-facing sides (i.e., the sides facing the median acceleration plane 26) of the holmium flying pole tips 20 lie 26 mm from the median plane 26, giving a pole gap at larger radii of 52 mm that is sufficient for the pole cryostat walls, dees, and circulating beam. In the central region, there is an additional steel cone 24 (with an aperture for external ion injection) and an accompanying holmium ring 32 at an interior portion of the main pole 20 to produce a negative field gradient that gives weak focusing at injection. While the holmium poles 20 sit within their cryostat, the cone 24 may be situated at room temperature within the pole gap; at zero radius from the central axis 28, the beam gap between the two cones 24 is 24 mm. The holmium poles 20 and superconducting coils 18 reside in a pair of cryostats operating at 4.2 K. The yoke 22, coils 18, and steel weak-focusing cone 24 are cylindrically symmetric, while the holmium flying poles 20 have three-fold rotational symmetry. The yoke 22, coils 18, and steel weak-focusing cone 24 are cylindrically symmetric, whilst the holmium flying poles 20 have three-fold rotational symmetry.

A visualization of the OPERA model of the magnet structure is shown in FIG. 4, where the outer steel yoke 22 (diameter=1340 mm) has contained within it the holmium flying pole 20 (diameter=20 mm), which is flat on the beam-facing side but to which back-cuts (in the spiral-shaped elements) have been made. The weak-focusing steel cone 24 (diameter=88 mm) and holmium ring 32 (diameter=140 mm) may be seen overlying the center of the holmium pole piece 20. The dees, coil, and cryostat materials are not shown in this rendering.

Superconducting coils 18 are used to provide the strongest possible average magnetic field so as to minimize the cyclotron size, but we must also provide sufficient flutter to achieve stable AVF (strong) focusing at all beam radii. The magnetic field can be shaped by adjusting the thickness of the poles 20 with radius on the beam-facing side, but this shaping would increase the average gap between hills and, hence, reduce the variation in the AVF required for axial focusing; instead, we apply back-cuts on the opposite side (i.e., the side facing away from the median acceleration plane 26) of the pole 20—this is straightforward because the poles 20 are already not in physical contact with the yoke 22 (they are, of course, separated from the iron yoke 22 by the cryostat walls). Using back-cut poles 20 is a method that obtains the necessary isochronous field profile at all proton energies while maximizing the AVF.

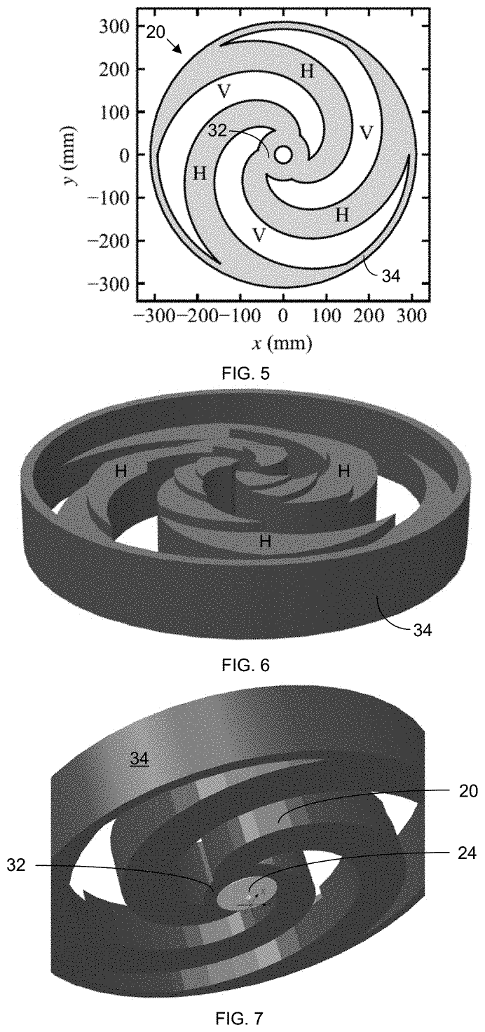

The pole shape is shown in FIG. 5. Each holmium pole 20 is formed into spiral hills (H) with a maximum thickness of 105 mm; the shape is Archimedean (r=aθ) with spiral parameter, a=70 mmrad⁻¹. The three hills (H) are mechanically connected by an outer ‘skirt’ ring 34 that shapes the isochronous field to facilitate extraction of the ion at the extraction radius, while an inner 3-mm thick holmium disk 32 covers the poles 20 on the beam-facing side and assists the steel ring and cone 24 to achieve weak focusing in the central region. As shown, the hills (H) are separated by valleys (V). In the central region, the hills (H) are connected by an inner ring 32 for weak focusing. At the outer radius, the hills (H) are connected by a ‘skirt’ 34 that helps shape the isochronous field. The central ring 32 and outer skirt 34 are convenient in terms of allowing each holmium pole 20 to be machined and installed as a single piece.

Back-cuts are applied to the opposite side of this pole 20, as shown in FIG. 6, which is a three-dimensional OPERA rendering of the back-cut surface of a holmium pole of 620 mm diameter. Six cuts are sufficient to achieve the required magnetic-field variation and quality. A three-dimensional OPERA rendering of a steel cone 24 (diameter 88 mm) and holmium ring 32 (diameter 140 mm) lying over the holmium pole 20 as seen from median plane 26 is shown in FIG. 7.

Holmium Pole Design

Focal Requirements Though the following discussion focuses on holmium pole design, poles formed of gadolinium and other rare-earth metals can be designed via a similar methodology.

In designing an isochronous magnetic field capable of supporting charged-particle orbits that are both radially and axially stable, we consider the betatron motion transverse to the particle trajectory (\ddot{x}, \ddot{z}) that is given by the following equations:

\ddot{x}=x₀ sin ν_{χ}ω₀t, and (3a)

\ddot{z}=z₀ sin ν_{z}ω₀t, (3b)

where ν_{χ} and ν_{z} are the radial and axial betatron tunes, respectively. For transverse particle motion that is bounded and that oscillates around the reference particle trajectory, we require real-valued tunes. The general expressions for the tunes (νₓ², ν_{z}²) in an N-sector isochronous cyclotron are approximately expressed as follows:

$$\begin{matrix}{v}_{x}^{2} = 1 - n + \frac{F ( r ) {n}^{2}}{{N}^{2}} + … , and & ( 4 a ) \\ {v}_{z}^{2} = n + F ( r ) [ 1 + 2 {tan}^{2} ξ ( r ) ] + \frac{F ( r ) {n}^{2}}{{N}^{2}} + … , & ( 4 b )\end{matrix}$$

where n is the field index and is expressed as follows:

$$n = \frac{r}{B} \frac{d B}{dr} , \qquad ( 5 )$$

F(r) is the root mean square (r.m.s.) flutter, expressed as follows:

$$F ( r ) = \frac{1}{2 π} \int {( \frac{B ( r , θ ) - {B}_{0} ( r )}{{B}_{0} ( r )} )}^{2} d θ , \qquad ( 6 )$$

and ξ=(r) is the angle that the edge of a spiral pole sector makes with a radial line drawn from the origin of the cyclotron. In the median plane of an isochronous cyclotron, B=γB₀ increases with radius, so Eq. 5 requires n<0. This requirement increases νₓ² in Eq. 4a and decreases ν_{z}² in Eq. 4b. Because we require real-valued tunes, the sums of the right-hand sides of Eqs. 4a and 4b must be positive. The challenge in designing an isochronous field is to simultaneously establish B=γB₀ and ν_{z}²>0. We see by Eq. 4b that, to compensate for a negative field index, we must create ample flutter (i.e., an AVF with a sufficiently varying B-field between the hills and valleys) and an appropriate spiral angle, ξ. A common choice of spiral is the Archimedean spiral described in polar coordinates by r=aθ, where a is a constant; for an Archimedean spiral, ξ(r)=arctan(r/a). In the design presented here, we have found that a choice of N=3 sectors combined with a central field, B₀=4.52 T; and an Archimedean spiral with a=70 mmrad⁻¹ can satisfy the requirement for an isochronous field with ν_{z}²>0.

Pole Design

Back-cuts were applied to the holmium poles using the OPERA code (Version 1882, Vector Fields Software, Cobham) and were adjusted manually using results derived from the cyclotron codes GENSPEO and Z3CYCLONE [see M. M. Gordon, Computation of Closed Orbits and Basic Focusing Properties for Sector-Focused Cyclotrons and the Design of ‘Cyclops’, 16 Particle Accelerators 39 (1983) and Z3CYCLONE Instruction Manual Version 4.0, 1993, MSU NCSL Accelerator Group]. A limited number of azimuthally symmetric cuts (steps) were applied, which will be straightforward to manufacture; similar steel poles have been machined by us for a lower-energy cyclotron using comparable numbers and sizes of cuts. An additional advantage of back-cut poles is that using a small number of cuts gives lower undulations around the desired isochronous field profile. This pole profile gives a minimum valley field of 4.1 T and a maximum hill field of 5.4 T; the overall median-plane (z=0) field is shown in FIG. 9.

Weak-Focusing Central Region Design

In the central region of an isochronous cyclotron, the AVF usually is not sufficient for axial focusing. No flutter is possible in the central region, so weak focusing is employed by applying a negative field gradient to maintain axial focusing; this field gradient is achieved using a steel cone 24 (with a diameter of 88 mm) and a holmium ring 32 (with a diameter of 140 mm), as shown in FIG. 7. The field resulting from the introduction of the weak-focusing components can be seen as a ‘bump’ in the radial B-field profile (giving a negative field gradient with respect to radius and, therefore, a positive field index, n) at low radius in FIG. 10. By Eq. 4b, we ensure ν_{z}²>0 and, hence, obtain axial stability. When employing the method of weak focusing in the central region of the cyclotron, it must be remembered that the introduced B-field ‘bump’ results in ions that have angular frequency, co, greater than the isochronous value, ω₀, and will, therefore, eventually fall out of phase with the accelerating RF voltage. This effect is tolerable as long as the protons are within a 90° phase window of the RF peak.

Superconducting Coil

Each superconducting coil pack 18 sits with its beam-facing side positioned 30 mm from the median plane 26, the poles 20 sharing a cryostat on either side of the room-temperature dees and vacuum vessel. Penetrations are made through the cryostats for dee stems, cavities, and mechanical supports. The coil parameters are shown in Table II, below.

TABLE II
(superconducting coil parameters
for the 70 MeV cyclotron):

| Parameter | Value |
|---|---|
| conductor material | NbTi |
| conductor type | cable in channels |
| total ampere-turns | 635 At |
| current density | 127 A mm⁻² |
| number of turns | 1250 |

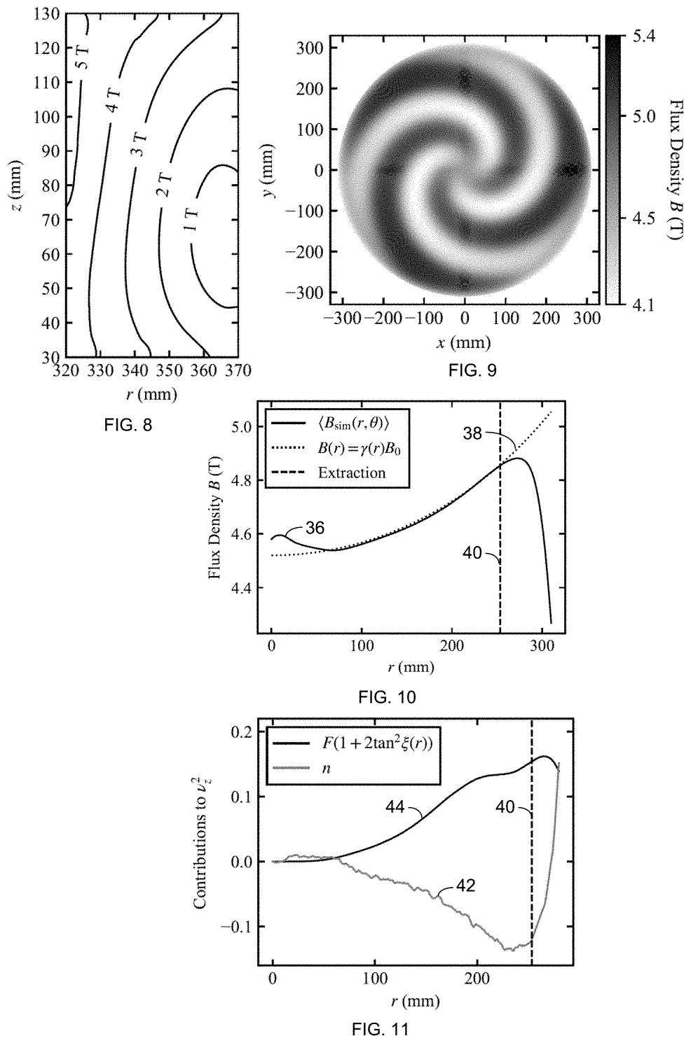

The variation of magnetic field through the coil pack 18 is shown in FIG. 8 and confirms that a NbTi conductor may be reliably used. Contours showing the variation of magnetic-field strength within a cross-section of the superconducting coil pack 18; the cross-section has been chosen through the azimuth at which the flux density is strongest. r=320 mm indicates the inner edge of the coil ring, and z=30 mm indicates the beam-facing edge. Over the coil-pack cross section, the magnetic field remains low enough that NbTi conductors may be used because the critical magnetic field of NbTi is typically between 8 and 9 T.

### Median-Plane Magnetic Field Analysis

Discussion now turns to the median-plane magnetic field produced by the magnet components discussed above.

The median plane is defined by z=0 in FIG. 3 and is the plane in which particles orbit. Vertical oscillations of particles (i.e., in the z-direction) occur out of this plane and the magnetic field encountered by these particles was calculated by an expansion of the median-plane field. A density map of B(r, 0, 0) is shown in FIG. 9. This field profile has been achieved through carefully chosen cuts on the side of the holmium pole that faces away from the median plane, termed ‘back-cuts’ (described, above). Cuts have been chosen to produce a field that satisfies the criteria for orbit stability. One of these criteria is that the azimuthally averaged radial profile of the field shown in FIG. 9 should be isochronous. FIG. 10 shows a comparison of the azimuthally averaged B-field 36 simulated by OPERA software with the ideal value 38, B(r)=γ(r)B₀; the ion-extraction radius 40 is also plotted. We see close agreement between the simulated 36 and the ideal 38 isochronous curves; and, as will be seen, infra, the agreement is sufficient for particles to stay within 90° of the phase at which the radiofrequency (RF) voltage peaks.

We see in FIG. 10 that there is a ‘bump’ in the azimuthally averaged field 36, [symbol] Bₛᵢₘ(r,θ) [symbol] , in the region, r=0-80 mm, which takes Bₛᵢₘ above the ideal isochronous value. This is the effect of the weak-focusing and transition rings discussed above, which have been deliberately included to introduce a positive field index, n, and thereby to give a region of axial stability at the cyclotron center. This focusing mechanism is in accordance with Eq. 4b; it is required in the central region of an AVF isochronous cyclotron, as here, the flutter term, F(1+2 tan² ξ(r)) would not be sufficient to cancel the negative field index, n, that would exist if the isochronous field extended into the center of the cyclotron. It must be remembered that an increase in the B-field above the isochronous value causes particles to orbit with angular frequency, ω, greater than the isochronous value, coo; as such, particles are prone to eventually fall out of phase with the RF; and care must, therefore, be taken that they remain within the phase window so as not be decelerated and lost. To maximize the orbit-radius range over which the weak-focusing region may exist, a phase offset is applied to particles injected into the central region of the cyclotron such that they initially lag the RF but are still accelerated; they, therefore, ‘catch up’ with the RF phase before reaching the isochronous region of the B-field. The success of this method is demonstrated in the particle-tracking simulation, above.

FIG. 11 shows the trade-off between the field index 42, n, and flutter terms 44 that contribute to ν_{z}² in the calculated B-field. It is useful to look at FIG. 11 with Eq. 4b in mind—we note the weak flutter term 44 in the region, r=0-80 mm, that is compensated by the positive field index 42 caused by the introduced ‘bump’ in the B-field. In the region where r>80 mm, we have an isochronous field profile; so the field index 42, n, becomes negative; however, here the flutter term 44 increases sufficiently to compensate. It is important to note that Eq. 4b is only an approximate expression for the axial tune and that FIG. 11 is a comparison plot of just the first two terms, the spiral factor term 44 and the field index 42—although these terms are dominant. In practice, the axial tune can be determined by numerical integration of differential equations describing the phase space of a charged particle in a magnetic field derived in M. M. Gordon, “Computation of Closed Orbits and Basic Focusing Properties for Sector-Focused Cyclotrons and the Design of ‘Cyclops’,” 16 Particle Accelerators 39 (1983), the result of which is given next.

Equilibrium Orbits

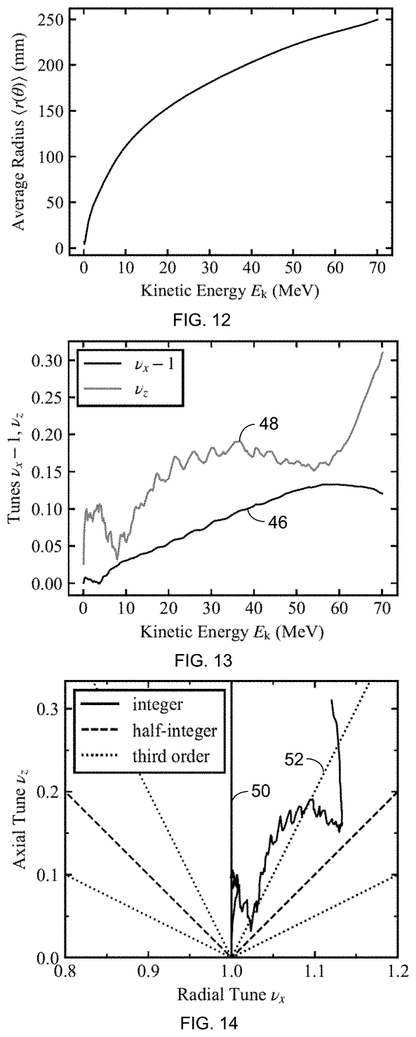

Equilibrium orbits are closed orbits in a magnetic field that correspond to a particle of given mass, charge, and energy. It is conventional to design a cyclotron so that equilibrium orbits with stable radial and axial focusing exist at all energies from injection to extraction. These orbits have been calculated here using the code, GENSPEO [see M. M. Gordon, “Computation of Closed Orbits and Basic Focusing Properties for Sector-Focused Cyclotrons and the Design of ‘Cyclops’,” 16 Particle Accelerators 39 (1983)], which is well-validated and has been used for the design of many operating cyclotrons. FIG. 12 shows that equilibrium orbits up to 70 MeV exist in our field design.

GENSPEO code can also calculate the radial and axial tunes, νₓ and ν_{z}, in our B-field. For oscillatory solutions to Eqs. 3a and 3b, we require that νₓ and ν_{z} are real; FIG. 13, which includes a plot 46 for νₓ−1 and a plot 48 for ν_{z} confirms that the tunes are real over the full acceleration range. We note a dip in ν₂ between kinetic energies of 5 MeV and 12 MeV. This dip occurs in the transition region from weak-to-AVF focusing and will result in an increase in the amplitude of axial oscillation of a particle (see FIG. 16, discussed, infra). As long as the axial oscillation amplitude remains within the bounds set by the dee aperture, the growth is tolerable; nevertheless, some further field refinement may be able to mitigate this tune dip so as to increase the tolerance of the cyclotron to manufacturing errors.

FIG. 14 shows the working point diagram for the 70-MeV design. There are two resonances (i.e., νₓ and ν_{z}) that do not cross quickly during acceleration (i.e., that take place over several turns). The first of these resonances 50 is the νₓ=1 resonance that results in a growth in radial amplitude in the central region of the cyclotron. The second resonance 52 is the 2νₓ−ν_{z}=2 resonance, which is crossed three times. The first crossing causes an increase in axial amplitude at around turn 50 in the cyclotron (see FIG. 16). The second crossing occurs around turn 170, but particle tracking performed with Z3CYCLONE code (see below) shows that this crossing does not cause significant increase in axial amplitude (FIG. 16). The third and final crossing is very fast and is unlikely to cause axial amplitude growth.

Particle Tracking

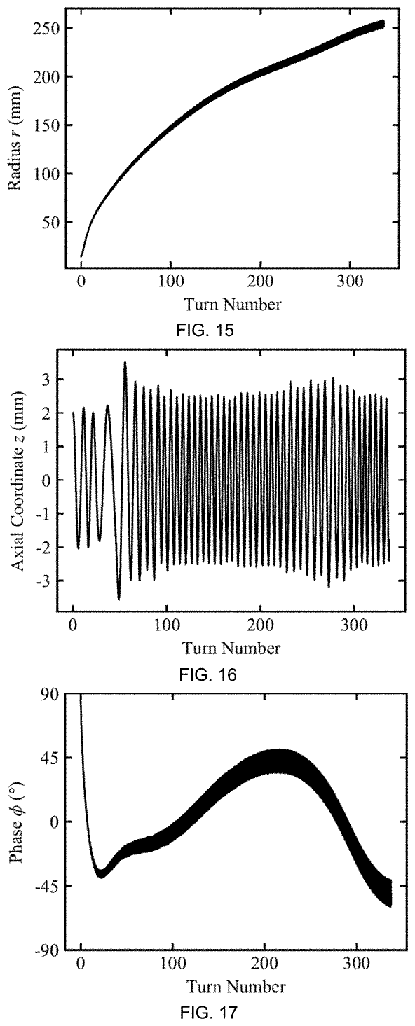

Particle tracking of a single proton has been performed using the Z3CYCLONE code. This is a three-part code, with parts one and two concerning the central region of the cyclotron and part three tracking the particle-to-extraction energy. We have used part three to track proton amplitude through the acceleration cycle. Here, the Z3CYCLONE code does not require an electric field map to describe the dee gap, and an impulse approximation for the proton-energy gain across this gap (that takes into account the RF phase and transit time factor) is sufficient. FIGS. 15 and 16 show the radial and axial coordinates of a proton tracked through the median-plane field of FIG. 9. The apparent thickness of the radius, as shown in FIG. 15, is due to the variation of radius with azimuth within a single turn—the orbit has a somewhat triangular shape at a given energy that reflects the varying bend radius from the three-fold-symmetric hills and valleys. In the example of FIG. 16, variation of axial-oscillation amplitude of a reference proton with turn number is shown with an initial axial amplitude of +2 mm; this plot was obtained using the Z3CYCLONE code using the field obtained from the OPERA software, assuming an average voltage gain at the dee crossing of 35.7 kV. The initial axial amplitude shown is a typical value obtained in working cyclotrons and is due to component misalignments; the overall axial amplitude growth is bounded and manageable within the available dee gap.

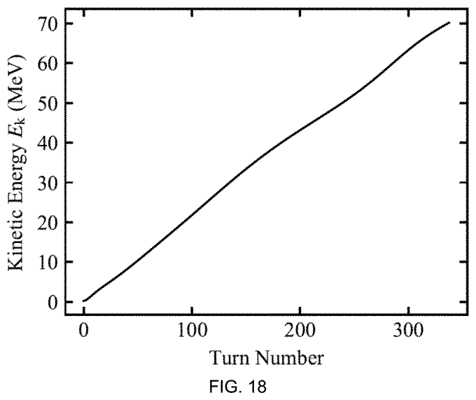

FIG. 17 shows the phase, ϕ, by which the RF leads or lags a reference proton, where positive values of ϕ correspond to the RF phase leading the proton phase. The accelerating voltage seen by a particle crossing a dee gap is given by V=V₀ cos ϕ, where V₀ is the maximum voltage of the dee (40 kV in this case). As long as |ϕ|90°, the particle will see a positive impulse of energy. The initial phase offset is set to 85° to account for the central weak-focusing region over which the orbital frequency of the particle is greater than the RF frequency. In general, an integral phase error of zero over the full acceleration cyclotron is required, and as can be seen in FIG. 17, that objective has been reasonably achieved. This design requires 336 turns for the proton to reach 70 MeV with an average energy gain of 34.7 kV per gap crossing, which is a reasonable number of turns for a 70-MeV proton cyclotron. FIG. 18 shows proton energy as a function of turn number over an acceleration cycle. We see that the rate of gain of the energy decreases in those regions where the relative phase, ϕ, is furthest from 0.

### Summary and Outlook

Combining the use of a rare-earth holmium pole with a room-temperature yoke and superconducting coil is a new method for magnet design that may be termed, “hyperferric”, in comparison to conventional superferric magnets that use ordinary iron pole tips. Hyperferric magnets allow greater flux concentration and thereby open a route to greater focusing variation than has been hitherto possible. We have demonstrated a design of a superconducting cyclotron that makes use of this advantage, and which we believe is the first realistic isochronous 70-MeV proton cyclotron with an average field above 4 T. The drastic reduction in cyclotron size to a yoke mass of less than 9 tons (<8,165 kg)—around one order of magnitude smaller than existing approaches—makes it very attractive for a variety of uses, such as particle therapy and isotope production; and there are no particular barriers to delivering a high dose rate suitable for such emerging techniques as FLASH radiotherapy. Cyclotrons are the workhorse proton source across many areas of industry, medicine and physical research; and our approach can greatly increase the accessibility of such sources to users in a variety of disciplines.

We have also demonstrated the advantages of a flying pole design, which, at the same time, allows the use of both a small cold mass and a back-cut pole; the latter maximizes the beam-plane flux density while providing sufficient AVF focusing, both important in minimizing cost. The resulting cyclotron—with a diameter of 1340 mm and a height of 862 mm—is far smaller than any other known source of monochromatic, high-current protons yet proposed, and far smaller than existing normal-conducting cyclotrons of the same energy. For example, such a source may be used for ocular therapy within the typical room size of an intensity-modulated-radiation-therapy (IMRT) system, and our approach may be scaled up within limits to deliver protons of higher kinetic energy for other purposes.

The hyperferric approach is not only useful for cyclotron design. The general approach of a cold, shaped flying holmium pole should be of interest in other types of magnetic systems; and we envisage that it may be utilized in such systems as high-gradient quadrupoles for particle accelerators, high-field wigglers for synchrotron radiation production, and applications where a compact, planar field of several tesla is desired; the back-cut field-shaping method described herein may be of benefit also in several of those applications.

In describing embodiments of the invention, specific terminology is used for the sake of clarity. For the purpose of description, specific terms are intended to at least include technical and functional equivalents that operate in a similar manner to accomplish a similar result. Additionally, in some instances where a particular embodiment of the invention includes a plurality of system elements or method steps, those elements or steps may be replaced with a single element or step. Likewise, a single element or step may be replaced with a plurality of elements or steps that serve the same purpose. Further, where parameters for various properties or other values are specified herein for embodiments of the invention, those parameters or values can be adjusted up or down by 1/100, 1/50, 1/20, 1/10, ⅕, ⅓, ½, ⅔, ¾, ⅘, 9/10, 19/20, 49/50, 99/100, etc. (or up by a factor of 1, 2, 3, 4, 5, 6, 8, 10, 20, 50, 100, etc.), or by rounded-off approximations thereof or within a range of the specified parameter up to or down to any of the variations specified above (e.g., for a specified parameter of 100 and a variation of 1/100, the value of the parameter may be in a range from 0.99 to 1.01), unless otherwise specified. Moreover, while this invention has been shown and described with references to particular embodiments thereof, those skilled in the art will understand that various substitutions and alterations in form and details may be made therein without departing from the scope of the invention. Further still, other aspects, functions, and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety for all purposes; and all appropriate combinations of embodiments, features, characterizations, and methods from these references and the present disclosure may be included in embodiments of this invention. Still further, the components and steps identified in the Introduction/Background section are integral to this disclosure and can be used in conjunction with or substituted for components and steps described elsewhere in the disclosure within the scope of the invention. In method claims (or where methods are elsewhere recited), where stages are recited in a particular order—with or without sequenced prefacing characters added for ease of reference—the stages are not to be interpreted as being temporally limited to the order in which they are recited unless otherwise specified or implied by the terms and phrasing.

What is claimed is:

1. A compact rare-earth superconducting cyclotron, comprising:
a magnetic yoke defining a chamber contained within the magnetic yoke;
a pair of superconducting coils contained in the chamber defined in the magnetic yoke, wherein the superconducting coils are positioned on opposite sides of a median acceleration plane in the chamber; and
a pair of rare-earth poles, wherein each rare-earth pole comprises a rare-earth metal and is contained in the chamber defined in the magnetic yoke on opposite sides of the median acceleration plane, and wherein each of the rare-earth poles extends inward toward a central axis from one of the superconducting coils, is physically separated from the magnetic yoke, and is separated by at least 5 cm from the other rare-earth pole.

2. The compact rare-earth superconducting cyclotron of claim 1, wherein the rare-earth metal is holmium.

3. The compact rare-earth superconducting cyclotron of claim 1, wherein the rare-earth metal is gadolinium.

4. The compact rare-earth superconducting cyclotron of claim 1, wherein the magnetic yoke comprises iron.

5. The compact rare-earth superconducting cyclotron of claim 1, wherein each of the rare-earth poles includes an outer surface facing away from the median acceleration plane, and wherein the outer surface features a cut profile that adjusts a magnetic-field profile generated in the median acceleration plane.

6. The compact rare-earth superconducting cyclotron of claim 1, further comprising a pair of cryostats, each containing one of the rare-earth poles and one of the superconducting coils.

7. The compact rare-earth superconducting cyclotron of claim 1, further comprising an ion source configured to inject an ion into the median acceleration plane for acceleration therein.

8. The compact rare-earth superconducting cyclotron of claim 1, wherein the cyclotron is an isochronous cyclotron.

9. The compact rare-earth superconducting cyclotron of claim 1, further comprising at least one cryogenic refrigerator thermally coupled with the superconducting coils and with the rare-earth poles.

10. The compact rare-earth superconducting cyclotron of claim 1, further comprising an electrode in the chamber, wherein the electrode is coupled with a radiofrequency voltage source and is configured to generate a field that accelerates an ion orbiting outwardly across the median acceleration plane.

11. The compact rare-earth superconducting cyclotron of claim 1, wherein the rare-earth poles include an inner ring, an outer skirt ring, and spiral-shaped hills extending between the inner ring and the outer skirt ring.

12. A method for accelerating an ion in a cyclotron, comprising:
injecting an ion into a chamber defined inside a magnetic yoke at an inner radius;
providing a voltage from a radiofrequency voltage source to an electrode in the chamber to generate an oscillating field from the electrode that accelerates the ion in an outwardly spiraling orbit across a median acceleration plane;
using a cryogenic refrigerator to maintain (a) superconducting coils on opposite sides of the median acceleration plane and (b) rare-earth poles at a temperature at or below that at which a rare-earth metal of the rare-earth poles transitions to a ferromagnetic state, wherein the rare-earth poles are separated by a gap of least 5 cm across the median acceleration plane and physically separated from the magnetic yoke across the median acceleration plane;
providing a voltage to the superconducting coils to generate superconducting current in the superconducting coils, wherein the superconducting coils magnetize the rare-earth poles and the magnetic yoke, and wherein the superconducting coils, the rare-earth poles, and the yoke generate a radially increasing magnetic field in the median acceleration plane that accelerates the ion in an outwardly spiraling orbit from the inner radius to an outer extraction radius; and
extracting the accelerated ion from the chamber at the outer extraction radius.

13. The method of claim 12, wherein the ion extracted with an energy of at least 70 MeV.

14. The method of claim 12, wherein the yoke is maintained at room temperature as the ion is accelerated.

15. The method of claim 12, wherein a magnetic field of at least 4.5 T is generated in the median acceleration plane.
